(19) United States
(12) Patent Application Publication
(10) Pub. No.: US 2009/0017553 A1
(43) Pub. Date: Jan. 15, 2009

(54) Immunoassay-based microsensing using optical sensors

(75) Inventors: James B. Hoying, Tucson, AZ (US); Pierre Deymier, Tucson, AZ (US); Hugh Barnaby, Tempe, AZ (US)

Correspondence Address: OBLON, SPIVAK, MCCLELLAND MAIER & NEUSTADT, P.C., 1940 DUKE STREET, ALEXANDRIA, VA, 22314, US

(73) Assignee: Arizona Bd of Regents/Behalf of Univ. of Arizona, Tucson, AZ (US)

(21) Appl. No.: 11/808,656

(22) Filed: Jun. 12, 2007

Related U.S. Application Data
(60) Provisional application No. 60/812,756, filed on Jun. 12, 2006.

(51) Int. Cl. G01N 21/76

(52) U.S. Cl. 436/172; 422/52

(57) ABSTRACT

A biosensor device, system, and method for detecting biological material. The sensor includes a substrate including sample regions having attachable thereon an immobilized first species associated with the biological material and includes at least one optical sensor associated with the sample regions and configured to detect induced radiation from a second species selectively attached to the first species at the sample regions. The induced radiation provides an indication that the biological material is on the substrate. The system includes a processor in communication with the optical sensor and is configured to monitor the induced radiation from the second species. The method immobilizes a first species of the biological material on the at least one sample region, attaches a second species of the biological material to the first species, induces radiation from the second species, and detects the radiation with at least one optical sensor associated with the at least one sample region.

### CROSS REFERENCE TO RELATED APPLICATIONS

This application is related to and claims priority under 35 U.S.C. § 119(e) to U.S. Ser. No. 60/812,756 entitled “IMMUNOASSAY-BASED MICROSENSING” filed Jun. 12, 2006, the entire contents of which are incorporated herein by reference.

### STATEMENT REGARDING FEDERALLY SPONSORED RESEARCH

This invention was made with Government support under Contract No. 0303863 awarded by the National Science Foundation. The Government has certain rights in the invention.

### BACKGROUND OF THE INVENTION

1. Field of the Invention

The present invention relates to immunoassay systems and methods for detecting biological substances.

2. Discussion of the Background

Microarray technology has become a widely used tool for large-scale and high-throughput biology. Microarray technology permits parallel detection of thousands of addressable elements in a single experiment. In the past few years, microarray technology has shown its great potential in basic research, diagnostics and drug discovery. It has been applied to analyze antibody-antigen, protein-protein, protein-nucleic-acid, protein-lipid and protein-small-molecule interactions, as well as enzyme-substrate interactions. Recent progress in the field of microarrays includes surface chemistry, capture molecule attachment, protein labeling and detection methods, high-throughput protein/antibody production, and applications to analyze entire proteomes. U.S. Pat. Appl. Publ. No. 20050100969, the entire contents of which are incorporated herein by reference describes a substrate for protein microarrays, where compounds such as of nitrocellulose, poly(styrene-co-maleic anhydride) and polyvinylidene fluoride are mixed with a glycidyloxypropyltrimethoxysilane (GPTS) to form a coating for a solid support upon which proteins can be deposited.

Efficient immobilization of a protein is a one factor in determining the overall success of a microarray. If the immobilized probes are not correctly oriented on the microarray surface or are denatured, it can dramatically affect the downstream protein interaction events. Therefore, the selection of substrate material and its surface treatment pose a challenge in the manufacturing of protein substrates. Conventional treatment of substrate for a microarray involves a dual-layer modification process, where the modified substrate contains a buffer layer and a reaction layer. The buffer layer serves to connect the substrate and the reaction layer, where one end of the buffer compound may react with the substrate and the other end may react with the reaction layer to help immobilize the reaction layer on the substrate. The reaction layer includes a compound having the function of protein-capture agent, which can immobilize protein on the reaction layer and furthermore on the substrate through the buffer layer.

Immunoassay is a biochemical test that measures the concentration of a substance in a biological liquid using the reaction of an antibody or antibodies to its antigen. An antibody or immunoglobulin is a large Y-shaped glycoprotein of the immunoglobulin superfamily used by the immune system to identify and neutralize foreign objects like bacteria and viruses. An antibody contains two sites called paratopes that recognize a specific target, which is called an antigen. Paratopes can be thought of as similar to locks and are specific for just one particular part of the antigen called an epitope, which can be considered similar to a key. This specific lock and key interaction permits an antibody to tag a microbe or an infected cell for attack by other parts of the immune system.

The assay takes advantage of the specific binding of an antibody to its antigen. Monoclonal antibodies are often used as these antibodies only usually bind to one site of a particular molecule, and therefore provide a more specific and accurate test, which is less easily confused by the presence of other molecules. The selectivity and sensitivity of immunoassays permit the detection of a number of biomolecules and agents.

Immunoassays are routinely used in the food industry, environmental surveying, basic science research, and drug discovery efforts. In addition, immunoassay techniques are utilized in clinics as a diagnostic and prognostic tool. Immunoassay-based technologies rely on the detection of signals generated by a reporter system optically coupled directly or indirectly to regions where signals from the relevant antibodies such as for example a fluorescence signal, a calorimetric readout, a chemiluminescence, or radioactive activity are detected.

Chemiluminescence (CL) is a common technique for a variety of detection assays in biology. In one commonly used example, a horseradish peroxidase enzyme (HRP) is tethered to the molecule of interest (usually through labeling an immunoglobulin that specifically recognizes the molecule). This enzyme complex reacts with a sensitized reagent in the vicinity of the molecule of interest, which on further oxidation by hydrogen peroxide, produces a triplet (excited) carbonyl which emits light when it decays to the singlet carbonyl. Chemiluminescence has permitted detection of minute quantities of biomolecules.

However, generally, large relatively bulky equipment has been employed to detect the chemiluminescent signals making it difficult to translate any immunoassay for use in field applications. Nonetheless, immunoassays have been used for the detection of salmonellae and E. Coli in food samples, for the detection of cholera toxin, for the detection of anti-p53 antibodies in human sera, for the screening for antibodies specificity, and for biomolecular studies (e.g., protein-protein interactions).

This work and other background work are described in more detail in the following references. The entire contents of each reference are incorporated herein by reference.
1. Akkoyun, A. and U. Bilitewski. 2002. Biosens. Bioelectron. 17:655-664;
2. Askari, M., J. P. Alarie, M. Moreno-Bondi, and T. Vo-Dinh. 2001. Biotechnol. Prog. 17:543-552;
3. Buchsman, S. and T. McCreery. BAA 03-07 2002;
4. Delamarche, E., A. Bernard, H. Schmid, B. Michel, and H. Biebuyck. 1997. Science 276:779-781;
5. Delehanty, J. B. and F. S. Ligler. 2003. Biotechniques 34:380-385;
6. Gosch, M., A. Serov, T. Anhut, T. Lasser, A. Rochas, P. A. Besse, R. S. Popovic, H. Blom, and R. Rigler. 2004. J. Biomed. Opt. 9:913-921;
7. Haab, B. B., M. J. Dunham, and P. O. Brown. 2001. Genome Biol. 2:4.1-4.13;
8. Jackson, J., A. Morrison, P. Hurley, W. Harrell, D. Damjanovic, B. Lane, and A. Mathewson. IEEE International Conference on Microelectronic Test Structures, 165-170.2001;
9. Kems, S., D. Jiang, M. de la Bardonnie, F. Pelanchon, H. Barnaby, D. Kems, D. Schrimpf, B. Bhuva, P. Mialhe, A. Hoffman, and J.-P. Charles. IEEE Transactions in Nuclear Science 46, 1804-1808. 1999;
10. Luppa, P. B., L. J. Sokoll, and D. W. Chan. 2001. Clin. Chim. Acta 314:1-261
11. MacBeath, G. and S. L. Schreiber. 2000. Science 289:1760-1763;
12. Michaud, G. A., M. Salcius, F. Zhou, R. Bangham, J. Bonin, H. Guo, M. Snyder, P. F. Predki, and B. I. Schweitzer. 2003. Nat. Biotechnol. 21:1509-1512;
13. Moreno-Bondi, M. C., J. P. Alarie, and T. Vo-Dinh. 2003. Anal. Bioanal. Chem. 375:120-124;
14. Neuweiler, H., A. Schulz, M. Bohmer, J. Enderlein, and M. Sauer. 2003. J. Am. Chem. Soc. 125:5324-5330;
15. Rich, R. L. and D. G. Myszka. 2005. J. Mol. Recognit. 18:1-39;
16. Stoll, D., M. F. Templin, J. Bachmann, and T. O. Joos. 2005. Curr. Opin. Drug Discov. Devel. 8:239-252;
17. Taitt, C. R., J. P. Golden, Y. S. Shubin, L. C. Shriver-Lake, K. E. Sapsford, A. Rasooly, and F. S. Ligler. 2004a. Microb. Ecol. 47:175-185;
18. Taitt, C. R., Y. S. Shubin, R. Angel, and F. S. Ligler. 2004b. Appl. Environ. Microbiol. 70:152-158;
19. Trabesinger, W., C. Hübner, B. Hecht, and U. Wild. Review of Scientific Instruments 73[8], 3122-3124. 2002;
20. Vanderberg, E., L. Bertilsson, B. Liedberg, K. Uvdal, R. Erlandsson, H. Elwing, and I. Lundstrom. Journal of Colloid and Interface Science 147[1], 103-118. 1991;
21. Zanchi, A., F. Zappa, and M. Ghioni. IEEE Transactions on Electron Devices 47[3], 609-616. 2000;
22. Zhang, F. and M. P. Srinivasan. 2004 Langmuir 20:2309-2314;
23. Zhang, J., K. O. Voss, D. F. Shaw, K. P. Roos, D. F. Lewis, J. Yan, R. Jiang, H. Ren, J. Y. Hou, Y. Fang, X. Puyang, H. Ahmadzadeh, and N. J. Dovichi. 1999 Nucleic Acids Res. 27:e36.

### SUMMARY OF THE INVENTION

In one embodiment of the present invention, there is provided a biosensor device for detecting biological material. The sensor includes a substrate including sample regions having attachable thereon an immobilized first species associated with the biological material and includes at least one optical sensor associated with the sample regions and configured to detect induced radiation from a second species attached to the first species at the sample regions. The induced radiation provides an indication that the biological material is on the substrate.

In one embodiment of the present invention, there is provided a system for detecting biological material. The system includes a substrate including sample regions having attachable thereon an immobilized first species associated with the biological material and includes at least one optical sensor associated with the sample regions and configured to detect induced radiation from a second biological species attached to the first species. The induced radiation provides an indication that the biological material is on the substrate. The system includes a processor in communication with the optical sensor and configured to monitor the induced radiation.

In one embodiment of the present invention, there is provided a method for detecting biological material. The method immobilizes a first species of the biological material on the at least one sample region, attaches a second species of the biological material to the first species, induces radiation from the second species, and detects the radiation with at least one optical sensor associated with the at least one sample region.

It is to be understood that both the foregoing general description of the invention and the following detailed description are exemplary, but are not restrictive of the invention.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIG. 1 is a schematic illustrating a general approach for forming an immunoassay-based microsensor device of the present invention.

FIG. 2A is a schematic illustrating the structural configuration of one immunoassay-based microsensor device of the present invention, according to one embodiment of the present invention;

FIG. 2B is a schematic illustrating the selective attachment process for forming an immunoassay-based microsensor device of the present invention, according to one embodiment of the present invention;

FIG. 2C is a schematic illustrating various suitable immobilization layers used in the present invention;

FIG. 3 is a schematic illustrating immunoglobulin immobilization and detection on a GPTS coated substrate;

FIG. 4A is a schematic illustrating a typical avalanche photodiode sensor, as used in one embodiment of the present invention;

FIG. 4B is a schematic illustrating immunoglobulin attachment to a GPTS coated substrate, according to another embodiment of the present invention;

FIGS. 5A and 5C are schematics illustrating a graphic representation (a) and actual pictures (b, c) of an avalanche photodiode array, as used in one embodiment of the present invention;

FIG. 6 is a schematic illustration of APD detection of chemiluminescence from antibody/antigen interactions;

FIGS. 7A and 7B are schematics illustrating a background analysis method (identification and removal) according to one embodiment of the present invention;

FIG. 8 is a schematic depicting a system according to one embodiment of the present invention; and

FIG. 9 is a schematic depicting a corroboration technique of the present invention.

### DETAILED DESCRIPTION OF THE EMBODIMENTS

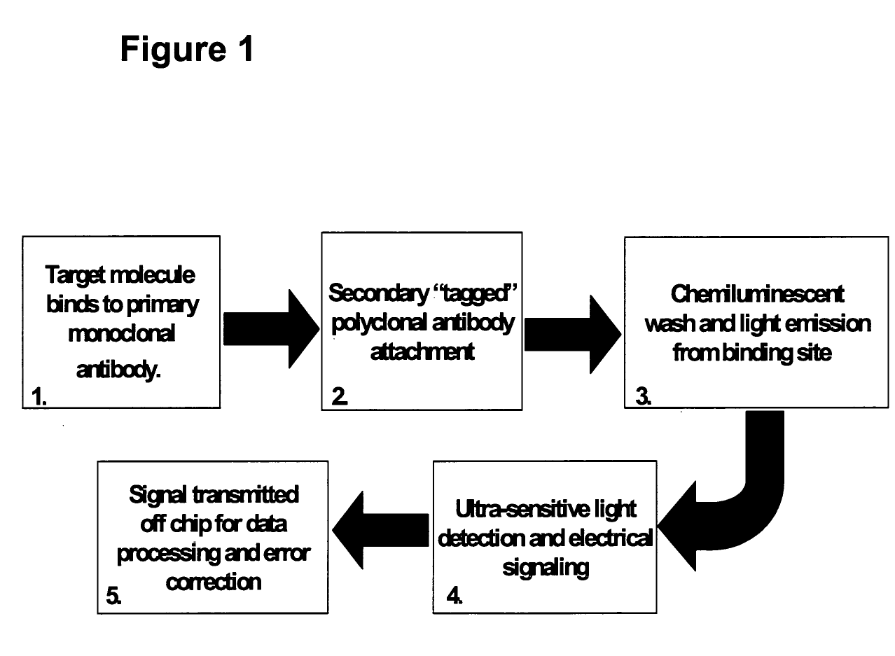

Referring now to the drawings, wherein like reference numerals designate identical, or corresponding parts throughout the several views, and more particularly to FIG. 1, FIG. 1 is a schematic illustrating a general approach for forming an immunoassay-based microsensor device of the present invention. Initially, a target molecule in an applied solution bonds to a primary monoclonal antibody already present on an assay template. Afterwards, a secondary polyclonal antibody is attached. The secondary polyclonal antibody is tagged with a luminescent agent. In one embodiment of the present invention, the luminescent agent is a chemiluminescent agent, and a chemiluminescent promoter is applied to generate chemiluminescence. In another embodiment, the luminescent agent is a fluorescent agent, and a fluorescent stimulating light is applied to generate fluorescence. Regardless of the type of luminescent agent used, the generated light from the tagged secondary polyclonal antibody is detected by an optical sensor which, in one embodiment, is a sensitive optical sensor such as for example an avalanche photodiode. The detected optical signals are collected and processed to provide an indication the presence of a target molecule in the sample solution.

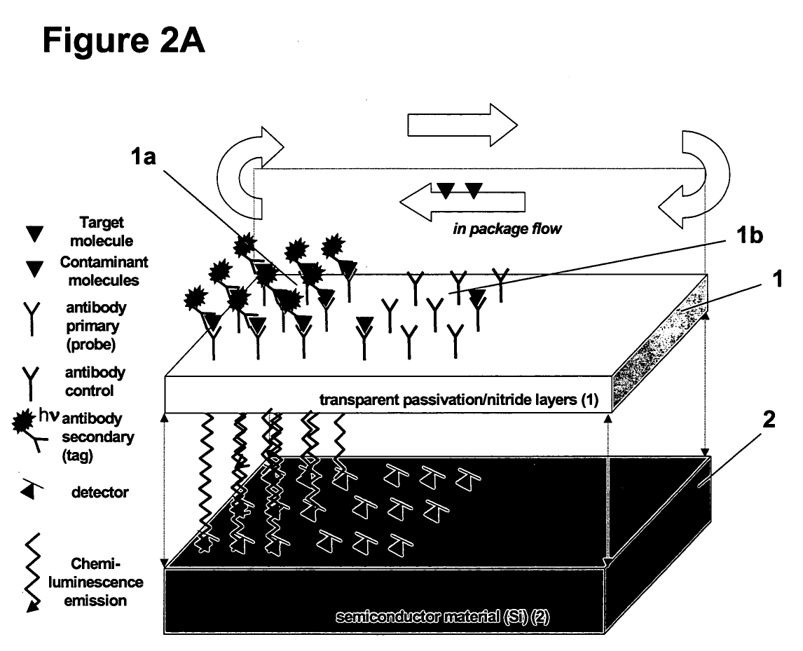

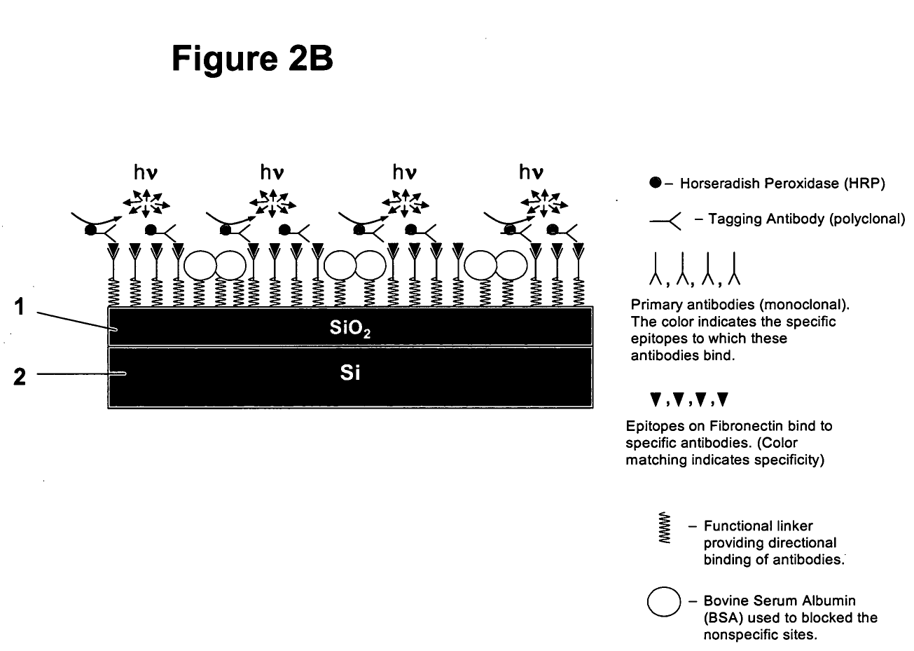

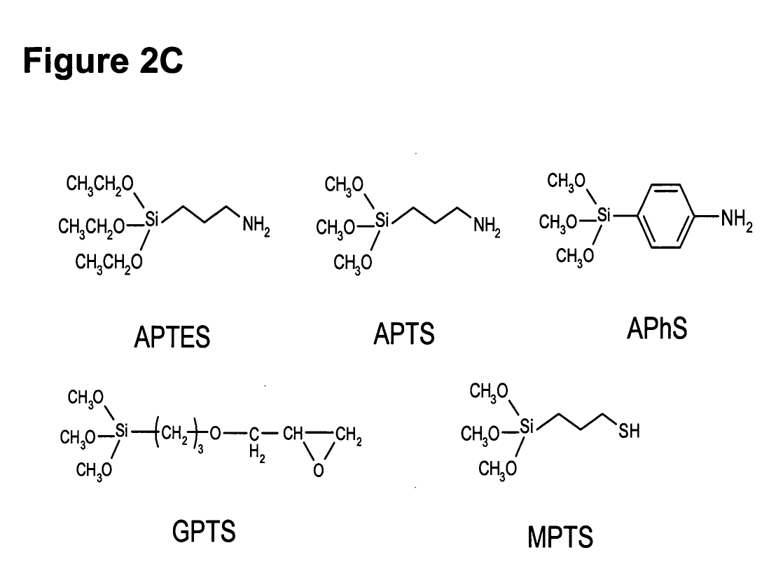

FIG. 2A is a schematic illustrating the structural configuration of one an immunoassay-based microsensor device of the present invention, according to one embodiment of the present invention In this device, a sample template 1 such as a transparent passivation layer over a semiconductor die 2 containing an array optical sensors 4 has a first species 6 (e.g, a primary antibody) attached to the sample template 1 in a sample region 1a. A control region 1b includes a regions where antibodies different than the primary antibody (i.e., control antibodies) are attached

A solution containing target molecules 8 of interest and perhaps contaminants is applied to the sample template 1. As shown by way of illustration in FIG. 2A, many of the target molecules 8 (and some of the contaminants) attach to the primary antibodies. Contaminants are expected to be as likely to attach to the primary antibody sites as well as the control antibody sites. A tagged secondary species 10 (e.g., a secondary antibody) including a luminescent agent is applied for example by solution to the sample template 1. The tagged secondary species is a species which selectively attaches to the target molecule and not the first species.

Thus, as shown by way of illustration in FIG. 2A, the tagged secondary species 10 primarily attaches to the target molecule and not the contaminants. Accordingly, when the luminescent agent is activated, those sites on the sample template 1 having the target molecule adhered are the only sites which emit light. The emitted light radiation is then measured, in one embodiment using an array of optical sensors 8. The detected radiation provides an indication that the target molecule is on the substrate and thus was in the sample solution applied to the sample template 1.

Any of the secondary tagged antibodies which attach to the contaminants are as likely to attach to the contaminants in the control region 1b as in the sample region 1a. Thus, in one embodiment of the present invention, the number of contaminants “inadvertently” having a secondary tagged antibody and thus emitting light from the sample region 1a should equal roughly the same number of contaminants “inadvertently” having a secondary tagged antibody in the control region 1b, thus providing a way to account for light emission in the sample region 1b that is not produced by attached target molecules.

In one embodiment of the present invention, to be discussed in more detail later, a cover slip or cover piece fabricated separately from the semiconductor die 2 can be used as the sample template 1. In this embodiment, the cover piece is disposed over the semiconductor die 2 containing the array optical sensors 4, making the cover piece more of a disposable item. In one embodiment of the present invention, only one optical sensor may be needed.

The first species 6 in FIG. 2A are covalently attached to the sample template 1 by an immobilization layer which binds directly to the surface of the substrate. Typically, a silicon oxide surface on the semiconductor die (or the cover piece) is cleaned and treated to optimize binding of the first species 6 (e.g., an immunoglobulin) to the surface. A diagrammatic representation of the organic schema is shown below in FIG. 2B. One end of a molecular chain of an organosiloxane groups having methoxy groups (O—CH₃) are displaced permitting the organosiloxane molecule to bind to the silicon oxide surface of the sample template 1. The other end of the molecular chain containing for example amine (NH₂) groups or epoxide (COOH) groups interacts with the first species to thereby immobilize the first species on the sample template 1. Thus, by selective patterning of the immobilization layer, the present invention in one embodiment defines regions where target molecules are expected to bind to the surface of the sample template 1. These defined regions are disposed on the sample template 1 to be aligned with corresponding optical sensors in the semiconductor die or under the afore-mentioned cover piece, as shown in FIG. 2A.

FIG. 2C is a schematic illustrating various suitable immobilization layers used in the present invention For instance FIG. 2B shows complexes such as glycidoxypropyltriethoxysilane (GPTS), aminopropyltriethoxysilane (APTES), aminoethyltriethoxysilane (APTS), amino phenyl trimethoxysilane (APhS), and methacryloxypropyl tris(trimethylsiloxy)silane (MPTS). Specifically, by way of example, the immobilization layer of GPTS provides a covalent linkage between a silicon oxide surface and the immunoglobulin (or first species) to be immobilized. The methoxy groups (O—CH₃) on the GPTS are displaced when GPTS binds to the silicon oxide surface on the substrate. The immunoglobulin amino group reacts with the epoxide group on the GPTS, covalently linking the antibody to the substrate.

FIG. 2B illustrates a further embodiment of the present invention. Once the first species 6 or the primary antibodies have been immobilized on the surface, a passivation layer is applied to terminate any exposed sites of the GPTS. For instance, a solution of bovine serum albumin (BSA) can be used. This procedure helps to prevent secondary species tagged with the luminescent agent from inadvertently adhering to the GPTS or other surface immobilization layer. Following passivation of the immobilization layer, the sample solution containing the target molecules is applied as discussed above.

FIG. 2B illustrates still further another embodiment of the present invention. For a particular target molecule of interest, there are classes of antibodies which the target molecules are expected to bind to. For example, epitopes on fibronectin are expected to bind to specific known antibodies. By having on the sample template many different types of antibodies, false positive identifications can be reduced and confidence can be increased when the array indicates that luminescence only from those antibodies associated with the epitopes on fibronectin are observed.

Thus, the present invention in various of the embodiments addresses potential issues of poor predictability in traditional immunoassay procedures by utilization of combinations of different antibodies assembled in an array format with each antibody being directed against the same target molecule via different epitopes. This intended redundancy provided by the different antibodies in an array enables the use of statistics to determine the presence (or absence) of an agent to a high degree of accuracy. In addition, in one embodiment of the present invention, positive and negative antibodies are incorporated into the array to enable error correction and assess device activity. With this approach, it is possible to assemble arrays of APDs that can be designed to accommodate the antibody arrays to work in coordination with these combinatoric and error correction strategies to produce a highly effective molecular detector.

Sample Preparation Examples: Suitable substrates for the present invention include for example silicon substrates (e.g. 100 cm² in area) that have been thermally oxidized for example 1 hour at 1100° C. to produce an oxide layer thickness of around 0.5 μm. The oxidized substrates in this example here were then diced into for example 5.75 cm² samples and cleaned in a 1:5 (H₂O₂:H₂SO₄) piranha solution for 10 min. The substrate selection, dicing, oxidizing, and cleaning conditions provided in this disclosure is for purpose of illustration and is not otherwise intended to limit the present invention.

These procedures were followed by a thorough rinsing with deionized H₂O and immersing the samples in 1:100 HF solution for 1 min. Following another thorough rinsing with deionized H₂O, the substrates were dried under a stream of N₂ and stored in a desiccator under vacuum. The oxidized silicon is cleaned again with the piranha solution for 10 minutes. The substrate is then rinsed for 1 minute in a hydrofluoric acid solution that is diluted in water 1:100 from a fully concentrated solution. The substrates are then rinsed in deionized water and are dried again under a stream of nitrogen gas and stored in a desiccator under vacuum pressure.

Following this preparation, the substrates were then immersed in a 2% (v/v) solution of GPTS in hexane typically for 5 hrs under agitation. In particular, 3-Glycidoxypropyl-trimethoxysilane (GPTS) obtained from Gelest Inc was used. The substrates were then rinsed with hexane twice and then acetone twice, and are then dried with a stream of nitrogen gas and are ready for use. Various concentrations of GPTS (e.g., from 0.2 to 8%) and various times for the immersion (e.g., from 2-12 hrs) can be used. Other concentrations of GPTS in hexane and other solvents besides hexane could be used. Examples of suitable solvents are alcohols such as butanol, ketones such as acetone, esters such as ethyl acetate, ethers such as tetrahydrofuran, and aliphatic, aromatic and halogenated hydrocarbons such as hexane, benzene, toluene and chloroform. GPTS-coated substrates were used immediately for protein attachment.

After GPTS coating (using the above 2% GPTS in hexane example for 5 hrs.), it was observed that substrate surfaces were roughened and covered with aggregates, presumably formed from self-assembled GPTS molecules. Atomic force microscopy images of SiO₂ substrate prior to functionalization and after coating with GPTS show that the roughness values were 0.12 nm and 0.25 nm for the SiO₂ and GPTS coatings, respectively.

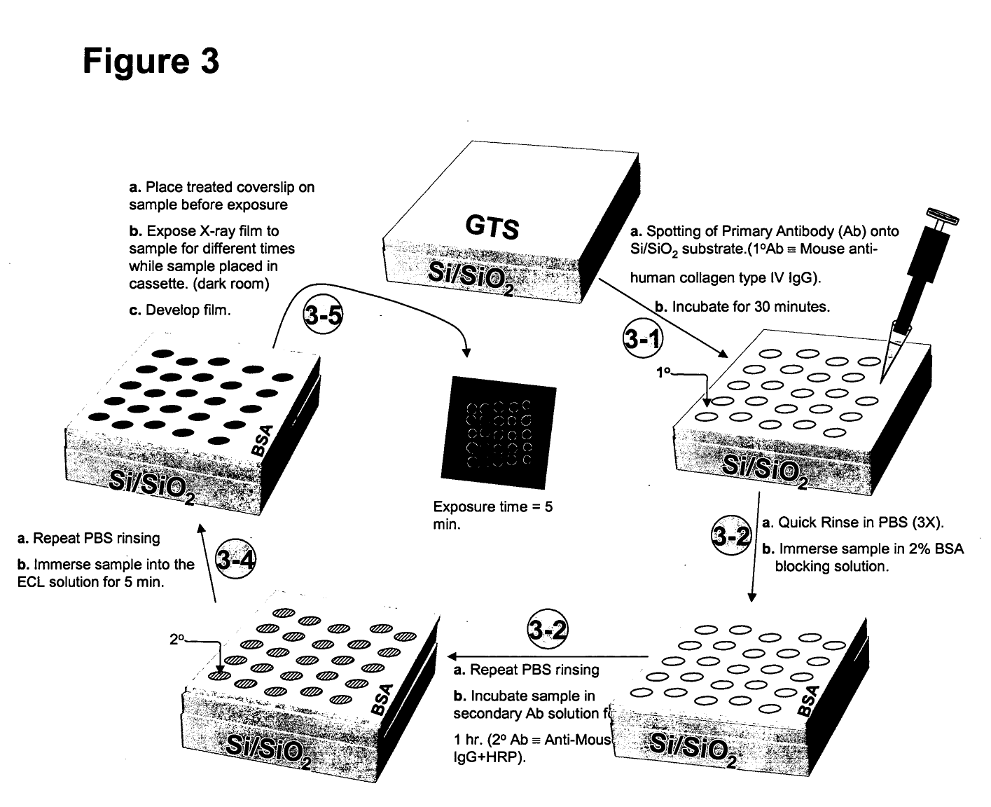

FIG. 3 is a schematic illustrating immunoglobulin immobilization and detection on a GPTS coated substrate. The diagrammatic representation in FIG. 3 depicts the steps discussed below used initially to test sample preparation and is provided herewith for detailed illustration of the present invention's immobilization process upon which many routine variations are within the scope of the present invention.

At Step 3-1, a concentrated solution of a primary antibody as the first species was diluted in phosphate buffered saline solution (e.g., PBS, pH range 7.4-7.7) and applied to a prepared sample template at respective spots. Mouse anti-Human Collagen type IV IgG (as the primary antibody) obtained from Chemicon International was used for this example. The primary antibody solution was added to a particular spot on the substrate, so that a different antibody could be used at different spots. The primary antibody solution was incubated for 30 minutes, but other times are also suitable for the present invention. By this step, the primary antibody is attached and immobilized on the substrate surface.

At step 3-2, the substrates were rinsed with PBS three times; the substrates were then immersed in a 2% bovine serum albumin (BSA in PBS) solution for 30 minutes to passivate any GPTS molecules which did not have the primary antibody or first species attached thereon.

At step 3-3, the substrates were then rinsed again with PBS for example three times. In this example, the target molecule to be detected was the primary mouse Mouse anti-Human Collagen type IV IgG. A secondary antibody solution is then added to the substrate for one hour. In this example, a horse radish peroxidase (HRP) tagged anti-mouse IgG (as the secondary antibody) obtained from Promega was used. The anti-mouse IgG secondary antibody binds to the primary mouse Mouse anti-Human Collagen type IV IgG. The HRP is a chemical luminescent agent.

At step 3-4, the substrate was immersed in a chemiluminescent (CL) solution. The CL solution used in this example was luminol. Luminol is described by Nieman, T., Detection Based on Solution-Phase Chemiluminescence Systems, in Chemiluminescence and Photochemical Reaction Detection in Chromatography, J. W. Birks, Ed.; VCH: New York, 1989; pp 99-123. Additionally, peroxyoxylate-based solutions can be used as described by Givens, R. S.; Schowen, R. L., The Peroxyoxalate Chemiluminescence Reaction, In Chemiluminescence and Photochemical Reaction Detection in Chromatography, J. W. Birks, Ed.; VCH: New York, 1989; pp 125-147, and described by Orosz, G.; Givens, R. S.; Schowen, R. L.; Crit. Rev. Anal. Chem. 1996, 26(1), 1-27. The entire contents of these articles on chemiluminescent solutions are incorporated herein by reference.

In general, luminol may be synthesized beginning from 3-nitrophthalic acid. First, hydrazine (N₂H₄) is heated with the 3-nitrophthalic acid in a high-boiling solvent such as triethylene glycol. A condensation reaction occurs, with loss of water, forming 3-nitrophthalhydrazide. Reduction of the nitro group to an amino group with sodium dithionite (Na₂S₂O₄) produces luminol. Hydrogen peroxide, an oxidant, reacts with luminol to produce light. This reaction is accelerated in the presence of a peroxidase agent. Other oxidants (e.g. hypochlorite) would be sufficient to react with the luminol reagent to produce light. In this embodiment of the present invention, a number of chemiluminescent agents including those conventionally used in immunoassay procedures can be applied to the sample regions. U.S. Pat. No. 5,637,508 entitled “Biomolecules bound to polymer or copolymer coated catalytic inorganic particles, immunoassays using the same and kits containing the same” is incorporated in its entirety herein by reference for its teaching of fluorescent agents suitable for the present invention. Krick et al. in “Enhanced Chemiluminescence Enzyme Immunoassay” Pure &Appl. Chem. vol. 59, no. 5, pp. 651-654, 1987, the entire contents of which are incorporate herein by reference, describe a number of CL solutions that are suitable for the present invention.

At step 3-5, an audioradiograph exposure was taken (in this demonstration example with an x-ray film) to verify the presence of the antibody on the substrate surface. The center depiction in FIG. 3 shows an example of the resultant developed x-ray film. As to be discussed in more detail later, in one embodiment of the present invention, optical sensors are used to monitor real time the luminescence or fluorescence.

Sample Measurement

As detection sources, avalanche photodiodes (APDs) have been used to measure fluorescence from biological materials. For example, APDs were used as detection modalities for fluorescence-based DNA sequencing. APDs, when reverse biased at their breakdown voltage, operate in a Geiger mode with single photon detection capability. In particular, APDs have been used in fluorimetry, even for single molecule detection. Besides single molecule detection, APDs have been demonstrated for the measurement of molecular concentrations. APDs have been used to study conformational changes for example in p53 protein-related peptides and to determine fluorescence lifetimes measurement.

Accordingly, in one embodiment of the invention, APDs provide an optimal detection method compared to other methods such as for example photodetectors, photodiodes, and charge coupled detectors (CCD) which are also suitable for the present invention. APDs offer fast switching time, compatibility with complementary metal-oxide semiconductor (CMOS) technologies, and excellent photon sensitivity, with the possible sensitivity of detecting single-photon events. The sensor system in one embodiment utilizes avalanche photodiodes in the single-photon (i.e. Geiger) mode. In this the mode, the APDs are among the most sensitive photo detectors, capable of detecting the arrival of one light. An APD is similar to a conventional PN junction diode, except for an added enhancement region, p(en), directly below the n-type cathode. The junction formed by the highly doped n-cathode and p-enhancement regions forms an active area, more susceptible to avalanche breakdown than the rest of the device.

During photon detection, the APD is reversed biased near its breakdown voltage. This creates an extremely strong electric field inside the device active area. Charged carriers, generated in the active region, are accelerated by the field to such high velocities that upon collision with the semiconductor lattice, more charged carriers are generated via impact ionization. The subsequent “chain reaction” results in an avalanche multiplication of transporting carriers inside the device, which causes a significant reverse current through the device and very high optical gain.

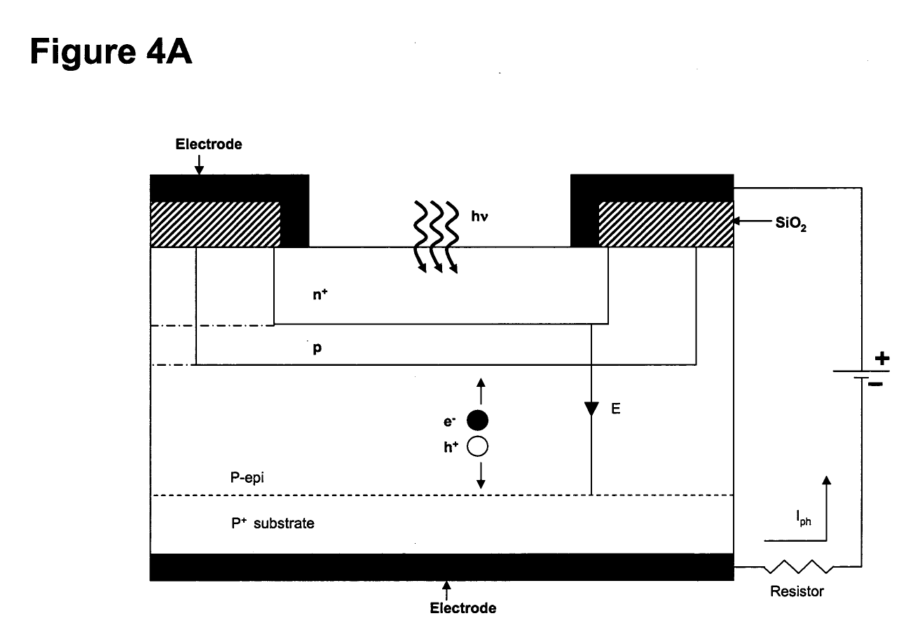

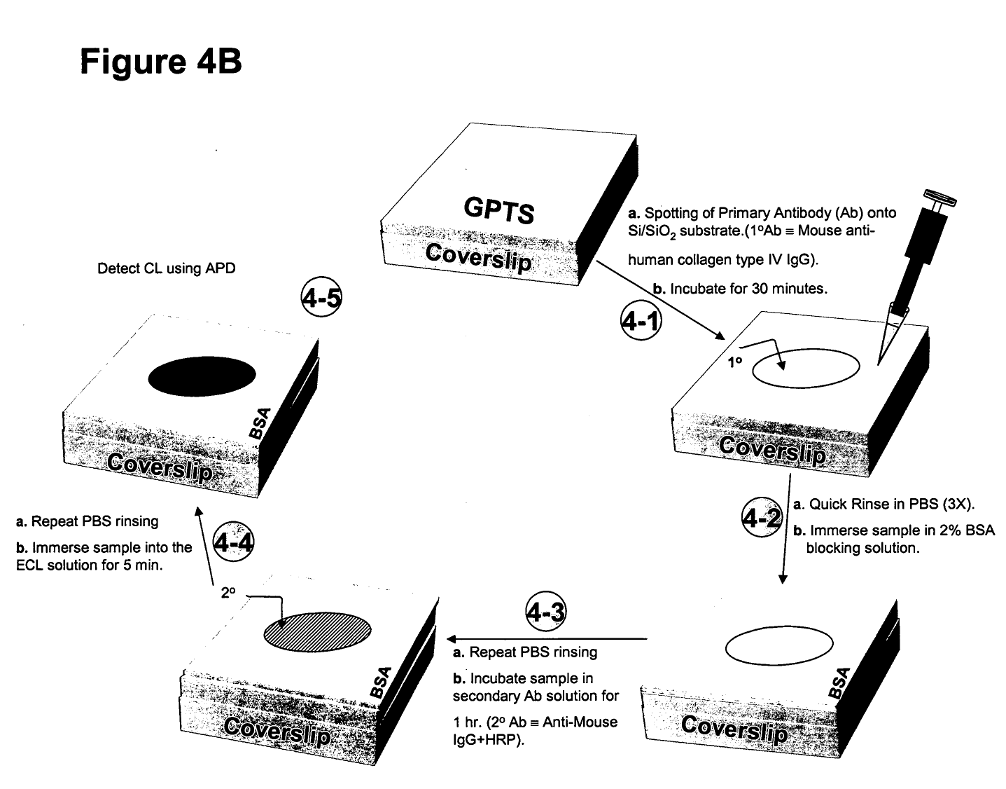

One configuration of an APD used to detect photons is shown below in FIG. 4A. The n and p symbols in FIG. 4A refer to the type of dopants added to the semiconductor to increase respectively the electron carrier and hole carrier concentrations. A voltage applied across the APD generates an electric field. Photons absorbed within the active area of the APD generate an electron hole/pair that can be measured by a change in a voltage potential.

Cover slip Example: FIG. 4B is a schematic illustrating immunoglobulin attachment to a GPTS coated cover slip acting as a substrate. The steps shown in FIG. 4b are similar to those in FIG. 3 and include at Step 4-1, a step in which a concentrated solution of a primary antibody is first diluted in phosphate buffered saline solution (e.g., PBS, pH range 7.4-7.7) and then applied to the cover slip at respective spots (only one spot is illustrated here in this example). The primary antibody solution was incubated for 30 minutes, but other times are also suitable for the present invention.

At step 4-2, the substrates were rinsed with PBS three times; the substrates were then immersed in a 2% bovine serum albumin (BSA in PBS) solution for 30 minutes. This procedure helps to prevent secondary species tagged with the luminescent agent from inadvertently adhering to the GPTS or other surface immobilization layer. Following passivation of the immobilization layer, the sample solution containing the target molecules is applied as discussed above.

At step 4-3, the substrates were then rinsed again with PBS for example three times. A secondary antibody solution is then added to the substrate for one hour. Horse radish peroxidase (HRP) tagged anti-mouse IgG (as the secondary antibody) was used for the chemical luminescent reactant.

At step 4-4, the substrate was immersed in a chemiluminescent (ECL) solution. At step 4-5, the chemiluminescence was measured by for example an avalanche photodiode.

Attachment of the APD to CMOS

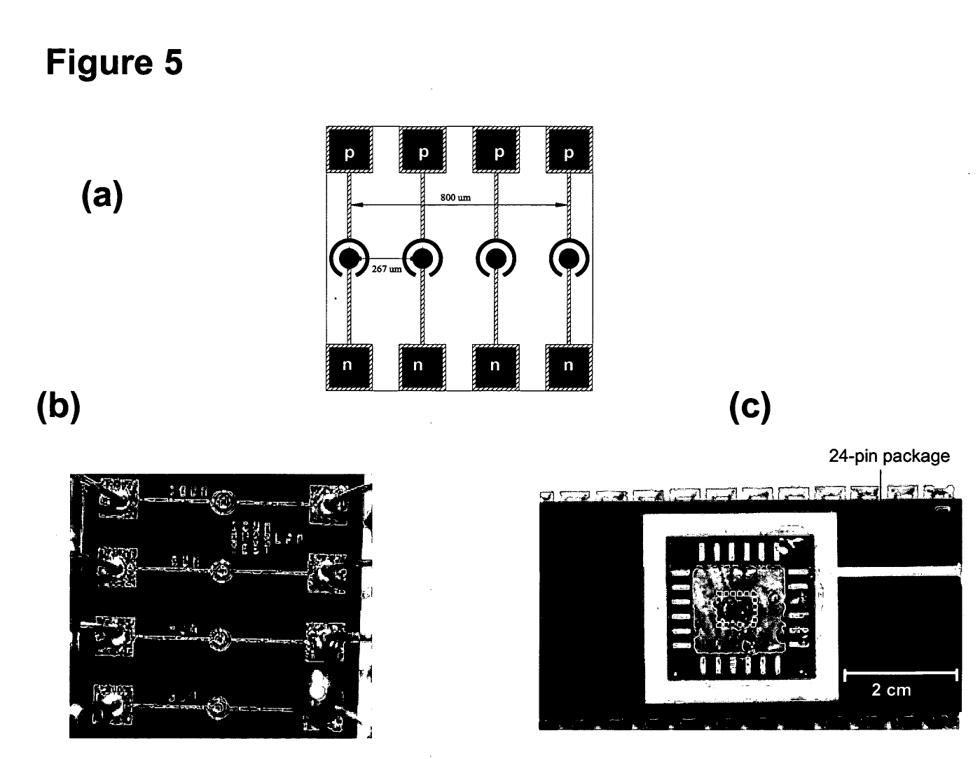

Suitable APDs for the present invention can be obtained from SensL Inc., (Cork, Ireland). Photodetectors for the APDs are received on bare die and are arranged as one-dimensional arrays. Each die had a series of either a 1×4 arrays as shown in FIG. 5 (or could be 1×10 APD arrays or other array sizes). FIG. 5(a) provides a graphic representation of the device with actual pictures in FIG. 5(b, c) of the fabricated avalanche photodiode array. The area of the array is approximately one square millimeter. FIG. 5(b) is an enlarged view of FIG. 5(c) and shows the wire bonding leads to each p and n-type contact region. Microelectronic packaging is utilized with wire bonding the device to the pins of the package in addition to epoxy coverage for electrical isolation. Physical separation of the electronics from the aqueous solutions can involve standard epoxy packaging. As noted above, a cover slip can be used to cover the APD arrays.

Briefly, in fabricating this specific device, the cover slip (over the APD array) was rinsed with ethanol followed by the addition of 2% GPTS solution which incubated at room temperature for two hours. Subsequently, the immunoassay described above was performed on the newly coated APD packages to attach the primary antibody. Following the addition of the HRP-tagged secondary antibody solution, a buffer saline solution was use as a rinsing solution. Afterwards, the cover slip attached to the APD array was submerged in a solution containing the enhanced chemiluminescent solution.

APD Sample Detection

Once the CL reagent was added to the substrate, the detection equipment was set to 26.72V. An oscilloscope was connected to the corresponding wires on the breadboard to sense a voltage change due to luminosity from the EL reagent. The substrate including the APD array was kept in a dark place, where the CL reagents will not come into contact with white light, which would have disturbed the measurements.

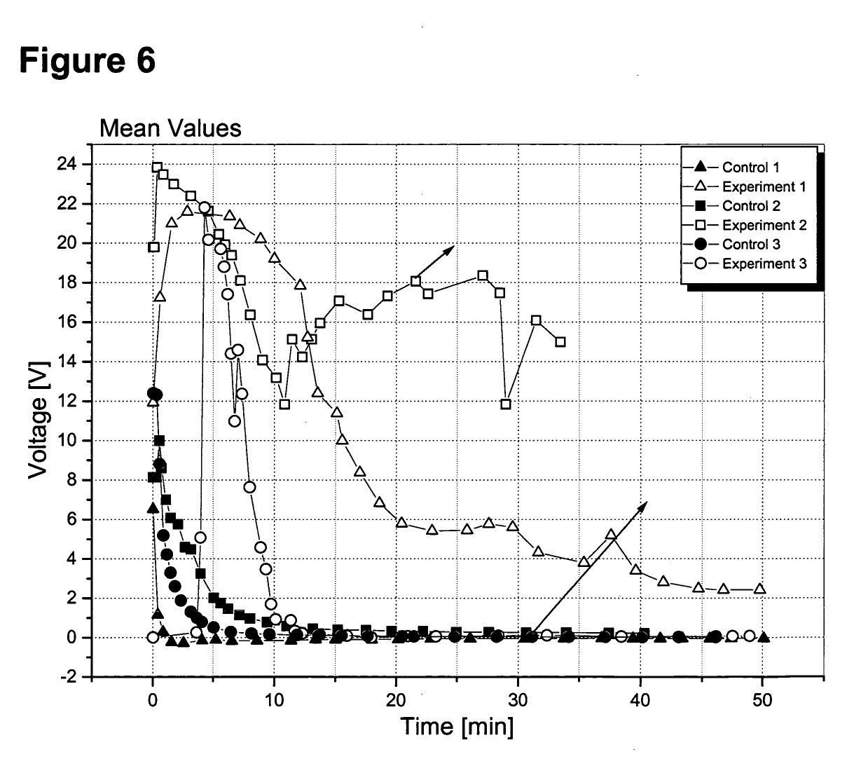

The quality of the response was measured by testing an APD coated with antibody (test) versus an APD coated with just PBS (negative control). Three experiments were performed using an antibody again human collagen type IV. The experiments in which the antibody was used verifies the ability of the APD to detect a difference in voltage potential when an antigen/antibody interaction is present versus when nothing is coated to the substrate surface. The results are shown in FIG. 6:

FIG. 6 is a schematic illustration of APD detection of chemiluminescence from antibody/antigen interactions. “Experiment” refers to the primary antibody attached to an APD, whereas “control” refers to only a PBS solution. The results in FIG. 6 show that APDs can discern a difference between the states of antigen presence and antigen absence. FIG. 6 shows the results from three separate paired experiments using three different packaged APDs. More specifically, FIG. 6 is a schematic illustration of output over time from APDs coupled to surface-bound antibody arrays. In FIG. 6, one APD is used for control condition and another APD is used for experimental condition. Open symbols represent responses from three separate APDs coupled to active antibodies arrays whereas closed symbols represent responses from the control conditions (no primary antibody arrays present) corresponding to each of the three experimental conditions. APD output from light input is measured as voltage.

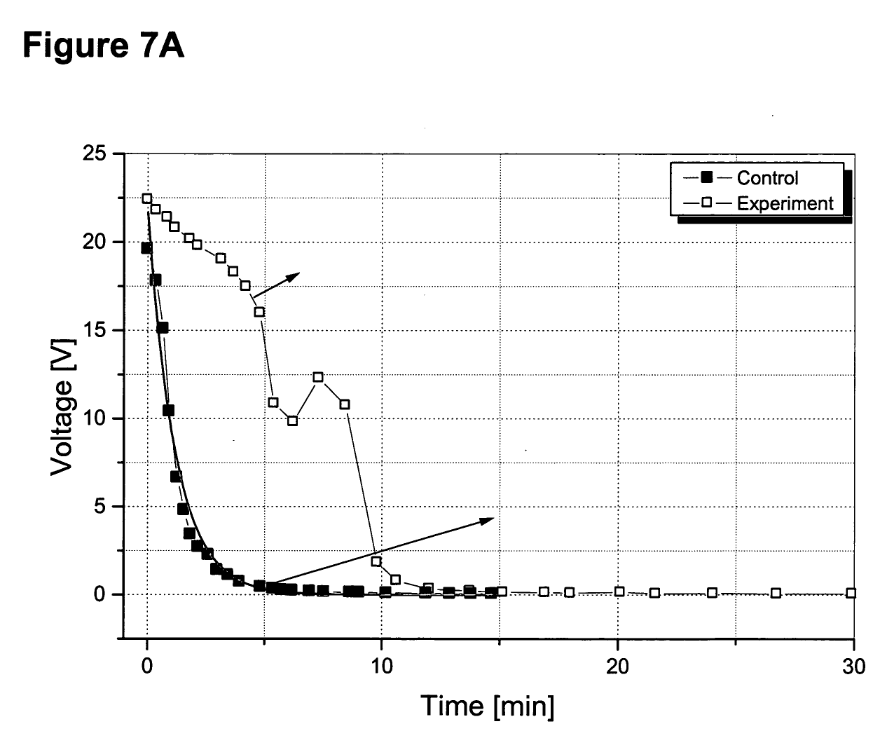

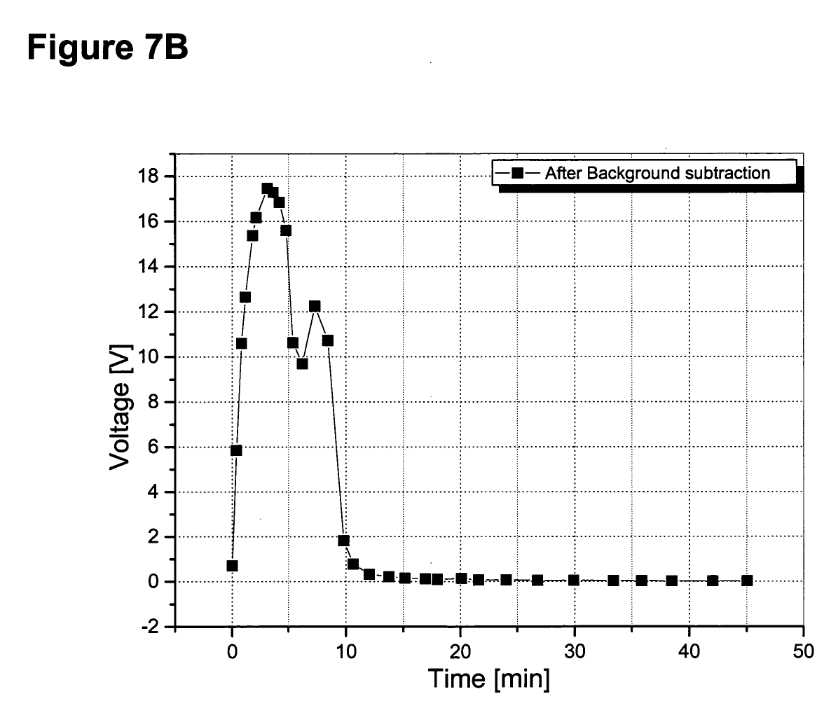

As is typical of chemiluminescence, an increase in light intensity occurred over the course of 5 min followed by a decline in intensity over time. In contrast, the control conditions, which did not involve a spotted antibody array, generated a very brief spike in light intensity followed by a rapid decline within the first 5 minutes. FIG. 7A is a schematic illustration of a background analysis method according to one embodiment of the present invention. The brief transients in the control samples (see lower decaying curve) are likely due to fluctuations in network impendence caused by the introduction of electro-chemical reagents and are not caused by the detection of chemiluminescence reactions, which as the experiments reveal, produce significantly longer and larger transient signatures (see top curve). A background subtraction can be made between these curves to produce the date in FIG. 7B.

Thus, in one embodiment of the present invention, avalanche photodiodes (APDs), based on complementary-metal-oxide-semiconductor (CMOS) technology, are utilized to provide a small, relatively inexpensive sensing device capable of detecting very low levels of light. In this embodiment, the array coupled with an APD produced a rapid readout (e,g, on the order of minutes) of molecular detection and provides a basic building block of a molecular sensing integrated circuit that includes: 1) the ability to detect the presence of specified molecules with a very high degree of accuracy; 2) the capability to use silicon semiconductor and MEMS fabrication technologies therefore be fabricated in high volumes at low costs; 3) the capability to operate remotely, enabling safe separation between a monitor and the hazard.

Immunoassays including those used in the present invention are known for their high sensitivities. The molecular epitope to antibody affinity is among the highest in biology, which enables the device to measure target quantities below 10⁻¹⁰ molar. Immunoassay technologies are also considered to be relatively specific. However, commercially available, portable assays were found, in a recent survey, to produce unacceptable levels of false positives and negatives. Additional studies have “noted a significant loss (50-70%) in the specificity of binding of cognate antigen-antibody pairs.” This corresponds to a false alarm rate range between 0.5 and 0.7.

The present invention addresses these potential issues of poor sensitivity through utilization of combinations of different antibodies, each of which is directed against the molecule via different epitopes, assembled in an array format. The redundancy provided by the numerous, different antibodies in an array permits in one embodiment of the present invention, the utilization of statistics to determine the presence (or absence) of an agent to a high degree of accuracy. In addition, in one embodiment of the present invention, positive and negative antibodies are incorporated into the array to enable error correction and to assess device activity.

Accordingly, in one embodiment of the present invention, arrays of APDs are assembled with the antibody arrays to work in coordination with these combinatoric and error correction strategies to produce a highly effective molecular detector.

The present invention in one embodiment realizes a portable, integrated immunoassay system which overcomes the challenge of assembling a detection device small enough to be portable yet sensitive enough to be useful by combining molecular printing techniques (discussed above) with highly sensitive solid-state detectors.

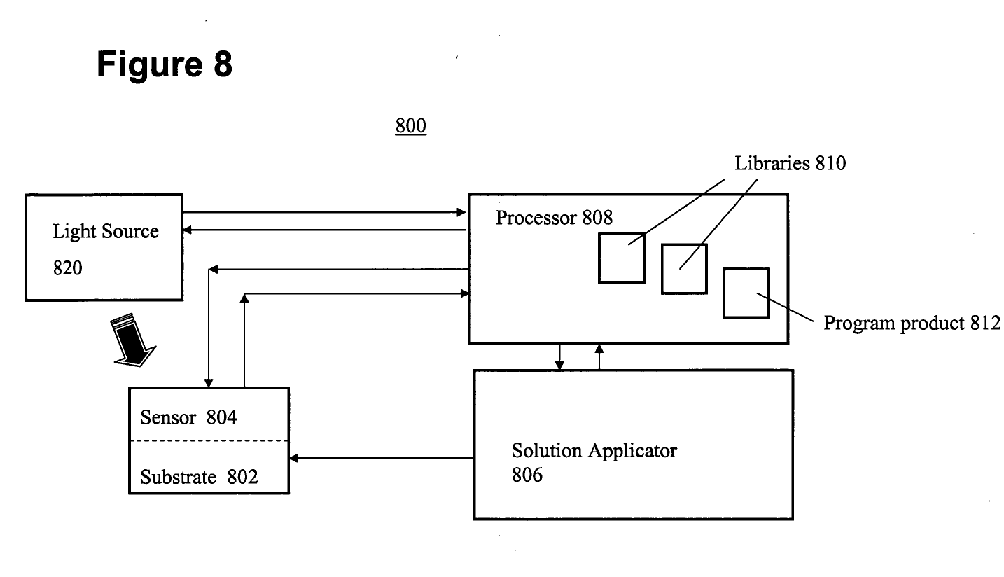

System Implementation: In one embodiment of the present invention, the above-described methods and equipment are included in system for detecting biological material, as shown in FIG. 8. The system 800 includes a substrate 802 having an adhesive which bonds a first biological species to the substrate and an optical sensor 804 associated with the substrate and configured to detect luminescent or fluorescent radiation from a second biological species attached to the first biological species. The detected radiation provides an indication that the biological material is on the substrate. The system 800 includes a processor 808 in communication with the optical sensor and configured to monitor the luminescent or fluorescent radiation. The system 800 includes a solution applicator 806. The solution applicator 806 can be for example robotic or automated equipment configured to apply the primary or secondary antibodies or other biological species including solutions containing the target molecule of interest for identification. The solution applicator 806 can be for example robotic or automated equipment configured to apply the chemiluminescent solutions or the solutions tagged with the luminescent or fluorescent agents.

The processor 808 includes a number libraries 810 stored in memory therein or otherwise accessible to the processor 808. For example, the libraries 810 can be stored remotely and can be accessed by the processor 808 via a network. The libraries 810 include stored patterns associated with particular predetermine cover slip or APD arrays, where the array positions are associated with a particular antibody/antigen pair or a control and sample grid. Thus, the processor 808 recognizes from array identification how to interpret the assay as to what biological species is present.

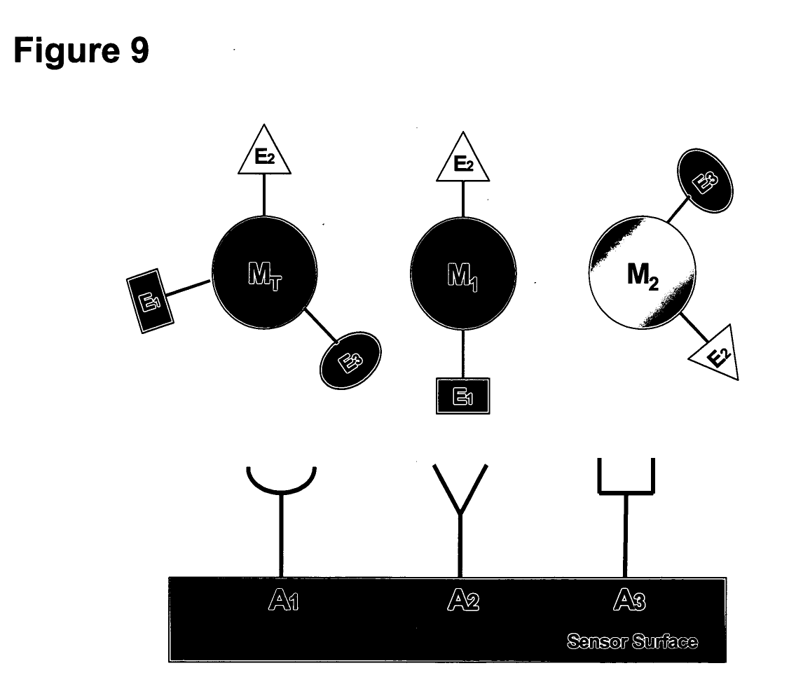

Furthermore, through predetermined array specifications, the processor 808 can address a common problem in the efficacy of immunoassay sensors (i.e., the non-specific binding at “on-probe” sites by “decoy” molecules, which share common epitopes with the targeted molecule. This scenario is illustrated in FIG. 9. Each target molecule (MT) has unique set of epitopes. The immunoassay is constructed by printing a subset of antibodies ({A1, A2, A3}), which bind specifically to a unique of the target epitope subset. Unfortunately, there may exist other decoy molecules (M1, M2), which may have one (or more) epitopes in common with the target molecule. Thus, even for a perfect immunoassay system, free of the aforementioned errors related to binding sensitivity, specificity and system noise, detection accuracy is fundamentally limited by probability and statistics. Yet, this strategy based on multiple primary antibody site functionalizations will reduce inherent limitations in molecule detection due to shared epitopes with the decoys.

Accordingly, in one embodiment of the present invention, the processor 808 may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

The processor 808 can be used to implement the method(s) of the present invention described above including the handling of process solutions, incubation times, solution rinsing, and optical detection of luminescent or fluorescent signals. The processor 808 can be used to implement the method(s) of the present invention described above including the processing of the optical data for background compensation and the identification of the target molecules through the use of predetermined arrays having different regions with differing antibodies or for the use of predetermined application of tagged secondary species to different sample regions on the surface of the cover piece. In these embodiments, the processor uses the predetermined information related to the array to correlate the optical data and provide positive identification of the target molecule.

The computer of the processor 808 houses for example a motherboard containing a CPU, memory (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer also includes plural input devices, (e.g., keyboard and mouse), and a display card controlling a monitor. The computer can be used to drive any of the devices or to store any of the data or program codes listed in the appended claims such as for example the reference or sample mass spectrum, among others.

Additionally, the computer may include a floppy disk drive; other removable media devices (e.g. compact disc, tape, and removable magneto-optical media (not shown)); and a hard disk or other fixed high density media drives, connected via an appropriate device bus (e.g., a SCSI bus, an Enhanced IDE bus, or an Ultra DMA bus). The computer may also include a compact disc reader, a compact disc reader/writer unit, or a compact disc, which may be connected to the same device bus or to another device bus.

The computer of processor 808 can include at least one computer readable medium. Examples of computer readable media are compact discs, hard disks, floppy disks, tape, magneto-optical disks, PROMs (e.g., EPROM, EEPROM, Flash EPROM), DRAM, SRAM, SDRAM, etc. Stored on any one or on a combination of computer readable media, the present invention can include software for controlling both the hardware of the computer and for enabling the computer to interact with a human user or to interface and interact with the sensors 804 and solution applicator 806 (and the automated or robotic equipment therein). Such software may include, but is not limited to, device drivers, operating systems and user applications, such as development tools.

Such computer readable media further includes the computer program product(s) or element(s) 812 of the present invention for performing the method(s) herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost.

The invention may also be implemented by the preparation of application specific integrated circuits or by interconnecting an appropriate network of conventional component circuits, as will be readily apparent to those skilled in the art.

The system described above can be implemented in various forms where immunoassay testing is routinely performed to provide either a portable or fixed station for immunoassay testing. Such systems include portable systems for monitoring of irrigation water quality in agricultural settings, portable systems for monitoring food quality in processing plants, fixed station systems for hospital settings, and fixed station systems for monitoring water quality in water plants. In these settings, the systems can be portable with the ability to remotely test, or the cover pieces can be used to remotely collect samples onto the functionalized surfaces. Afterwards, the cover pieces can be returned to a central processing unit serving as processor 808.

Furthermore, in one embodiment of the present invention, the system for detecting biological material described above detects induced radiation from a biological species not by induced chemiluminescence but rather induced by fluorescence. In this system, a substrate has attached at sample regions an immobilized first species associated with the biological material (as described above). The system includes at least one optical sensor associated with the sample regions and configured to detect fluorescent radiation from a second species attached to the first species at the sample regions. The fluorescent radiation provides an indication that the biological material is on the substrate. The system includes a processor in communication with the optical sensor to monitor the fluorescent radiation.

In one embodiment, this system includes a primary light source 820 configured to irradiate the sample regions with a primary light to induce the fluorescent radiation. In this embodiment of the present invention, a number of fluorescent agents including those agents conventionally used in immunoassay procedures can be applied to the sample regions. U.S. Pat. No. 5,650,334 entitled “Fluorescent Labeling Compositions and Methods for their Use” is incorporated in its entirety herein by reference for its teaching of fluorescent agents suitable for the present invention.

Thus, the present invention in one embodiment provides a platform for a number of detection and screening applications in which the substrate surface can be used to immobilize antibodies directed at target molecules suspected to be present in a sample. Alternatively, the functionalized APD chip surface serves as a capture surface able to bind and immobilize a broad spectrum of molecular species from a sample. For example, hybridoma preparations can be screened for the presence of the desired monoclonal antibody by passing the hybridoma cell supernatant over the GTPS surface to capture all antibodies in the sample and then following with either secondary antibody to the desired antibody or the antigen to be targeted in combination with a secondary antibody (as described before) to complete the assay. The presence of the desired antibody would be detected with the same APD-based chemiluminescence or fluorescence detection. In this regard, the chip surface indiscriminately captures molecules first and the specific target molecule is then identified using directed antibodies and APD-based detection.

Numerous modifications and variations on the present invention are possible in light of the above teachings. It is, therefore, to be understood that within the scope of the accompanying claims, the invention may be practiced otherwise than as specifically described herein.

1. A biosensor device for detecting a biological material, comprising:
a substrate including at least one sample region having attachable thereon an immobilized first species associated with the biological material;
at least one optical sensor associated with the at least one sample region and configured to detect induced radiation from a second species selectively attached to the first species, said radiation providing an indication that said biological material is on the substrate.

2. The device of claim 1, further comprising:
a chemiluminescent agent attached to the second species and configured to produce chemiluminescent radiation when a chemiluminescent solution reacts with the chemiluminescent agent.

3. The device of claim 2, wherein a reaction of the chemiluminescent solution with the chemiluminescent agent produces visible radiation.

4. The device of claim 2, wherein the chemiluminescent agent comprises peroxidase and the chemiluminescent solution comprises at least one of luminol and peroxyoxylate.

5. The device of claim 4, wherein the peroxidase comprises at least one of horse radish peroxidase.

6. The device of claim 2, wherein:
the first species comprise an antigen; and
the second species comprise an antibody which selectively attaches to the antigen.

7. The device of claim 1, further comprising:
a fluorescent agent attached to the second species and configured to produce fluorescent radiation when the fluorescent agent is exposed to primary radiation.

8. The device of claim 7, wherein the fluorescent agent is configured to produce visible radiation when exposed to the primary radiation.

9. The device of claim 1, further comprising a surface immobilization layer adhering the first species to the substrate in the at least one sample region.

10. The device of claim 9, wherein the surface immobilization layer comprises at least one of aminopropyltriethoxysilane (APTES), aminoethyltriethoxysilane (APTS), amino phenyl trimethoxysilane (APhS), and methacryloxypropyl tris(trimethylsiloxy)silane (MPTS).

11. The device of claim 1, wherein the substrate comprises an oxidized silicon substrate.

12. The device of claim 1, wherein the at least one sample region comprises:
a surface immobilization layer selectively disposed thereon; and
plural of the sample regions forming an array of the first species on the substrate.

13. The device of claim 1, wherein the at least one optical sensor comprises at least one of a photodetector, a photodiode, and a charge coupled detector sensitive to the induced radiation.

14. The device of claim 1, wherein the at least one optical sensor comprises an avalanche photodiode.

15. The device of claim 14, wherein the avalanche photodiode is operable in a Geiger mode which detects single photon radiation.

16. The device of claim 1, wherein the at least one optical sensor is fabricated in the substrate.

17. The device of claim 1, further comprising:
a cover piece transparent to the induced radiation, disposed on the at least one optical sensor, and configured to detect said radiation transmitted through the cover piece to the at least one optical sensor.

18. The device of claim 1, further comprising:
a processor in communication with the at least one optical sensor and configured to monitor the induced radiation.

19. The device of claim 1, wherein the at least one optical sensor comprises:
plural optical sensors associated with respective sample regions of the at least one sample region of the substrate, and configured to detect the induced radiation from the respective regions.

20. The device of claim 19, further comprising:
a processor in communication with the plural optical sensors and configured to monitor the radiation from the respective sample regions.

21. The device of claim 1, further comprising:
sample regions of the at least one sample region, disposed on the substrate where the first species is to be attached;
control regions on the substrate where the first species is not to be attached;
first optical sensors associated with the sample regions;
second optical sensors associated with the control regions; and
a processor configured to compare signals from the first and second optical sensors to thereby ascertain background radiation not associated with the induced radiation.

22. The device of claim 1, further comprising:
a first plurality of sample regions of the at least one sample region, disposed on the substrate where the first species is to be attached;
a second plurality of sample regions of the at least one sample region, disposed on the substrate where a third species is to be attached;
first optical sensors associated with the first plurality of sample regions;
second optical sensors associated with the second plurality of sample regions; and
a processor configured to compare signals from the first and second optical sensors to thereby determine relative concentrations of the first and third species.

23. A system for detecting biological material, comprising:
a substrate including at least one sample region having attachable thereon an immobilized first species associated with the biological material;
at least one optical sensor associated with the at least one sample region and configured to detect induced radiation from a second species selectively attached to the first species, said radiation providing an indication that said biological material is on the substrate; and
a processor in communication with the at least one optical sensor and configured to monitor the induced luminescent radiation.

24. The system of claim 23, further comprising:
a chemiluminescent agent attached to the second species; and
a chemiluminescent solution applicator configured to apply a chemiluminescent solution to the at least one sample region to produce chemiluminescent radiation when the chemiluminescent solution reacts with the chemiluminescent agent.

25. The system of claim 24, wherein a reaction of the chemiluminescent solution with the chemiluminescent agent produces visible radiation.

26. The system of claim 24, wherein the second species comprises peroxidase and the chemiluminescent agent comprises at least one of luminol and peroxyoxylate.

27. The system of claim 23, wherein:
the first species comprise an antigen; and
the second species comprise an antibody which selectively attaches to the antigen.

28. The system of claim 23, further comprising a surface immobilization layer adhering the first species to the substrate in the at least one sample region.

29. The system of claim 28, wherein the surface immobilization layer comprises at least one of aminopropyltriethoxysilane (APTES), aminoethyltriethoxysilane (APTS), amino phenyl trimethoxysilane (APhS), and methacryloxypropyl tris(trimethylsiloxy)silane (MPTS).

30. The system of claim 21, wherein the substrate comprises an oxidized silicon substrate.

31. The system of claim 21, wherein the at least one sample region comprises:
a surface immobilization layer selectively disposed thereon; and
plural of the sample regions forming an array of the first species distributed on the substrate.

32. The system of claim 23, wherein the at least one optical sensor comprises at least one of a photodetector, a photodiode, and a charge coupled detector sensitive to the induced radiation.

33. The system of claim 21, wherein the at least one optical sensor comprises an avalanche photodiode.

34. The system of claim 33, wherein the avalanche photodiode is operable in a Geiger mode which detects single photon radiation.

35. The system of claim 23, wherein the at least one optical sensor is fabricated in the substrate.

36. The system of claim 23, further comprising:
a cover piece transparent to the induced radiation, disposed on the optical sensor, and configured to detect said induced radiation transmitted through the cover piece.

37. The system of claim 23, wherein the processor is in communication with the optical sensor and is configured to monitor the induced radiation.

38. The system of claim 23, further comprising:
plural optical sensors associated with respective regions of the at least one sample region and configured to detect the induced radiation from the respective regions.

39. The system of claim 38, wherein the processor is in communication with the optical sensors and is configured to monitor the induced radiation from the respective regions.

40. The system of claim 23, further comprising:
sample regions of the at least one sample region, disposed on the substrate where the first species is to be attached;
control regions on the substrate where the first species is not to be attached;
first optical sensors associated with the sample regions;
second optical sensors associated with the control regions; and
said processor is configured to compare signals from the first and second optical sensors to thereby ascertain background radiation not associated with the induced radiation.

41. The system of claim 23, further comprising:
a first plurality of sample regions of the at least one sample region, disposed on the substrate where the first species is to be attached;
a second plurality of sample regions of the at least one sample region, disposed on the substrate where a third species is to be attached;
first optical sensors associated with the first plurality of sample regions;
second optical sensors associated with the second plurality of sample regions; and
a processor configured to compare signals from the first and second optical sensors to thereby determine relative concentrations of the first and third species.

42. The system of claim 23, wherein the second species comprises a fluorescent agent configured to produce fluorescent radiation when the fluorescent agent is exposed to primary radiation.

43. The system of claim 42, wherein the fluorescent agent is configured to produce visible radiation when exposed to the primary radiation.

44. The system of claim 42, further comprising:
a primary light source configured to irradiate said at least one sample region with a primary light to induce said fluorescent radiation.

45. A method for detecting biological material, comprising:
immobilizing a first species associated with the biological material on at least one sample region of a substrate;
attaching a second species of the biological material to the first species;
inducing radiation from the second species; and
detecting the radiation with at least one optical sensor associated with the at least one sample region, said radiation providing an indication that said biological material is on the substrate.

46. The method of claim 45, further comprising:
applying a chemiluminescent solution to the at least one sample region to produce chemiluminescent radiation when the chemiluminescent solution reacts with a chemiluminescent agent attached to the second species.

47. The method of claim 46, further comprising:
producing visible radiation from a reaction of the chemiluminescent solution with the chemiluminescent agent.

48. The method of claim 45, further comprising:
irradiating the at least one sample region to produce fluorescent radiation when the second species is exposed to primary radiation.

49. The method of claim 48, further comprising:
emitting visible radiation for the fluorescent radiation.

50. The method of claim 45, further comprising:
attaching an antigen as the first species; and
selectively attaching an antibody as the second species to the antigen.

51. The method of claim 45, wherein immobilizing a first species comprises:
adhering the first species to the substrate in the at least one sample region.

52. The method of claim 52, wherein adhering comprises:
applying a surface immobilization layer of at least one of aminopropyltriethoxysilane (APTES), aminoethyltriethoxysilane (APTS), amino phenyl trimethoxysilane (APhS), and methacryloxypropyl tris(trimethylsiloxy)silane (MPTS).

53. The method of claim 45, wherein immobilizing a first species comprises:
forming an array of the first species distributed on the substrate.

54. The method of claim 45, wherein immobilizing a first species comprises:
forming sample regions on the substrate where the first species are to be attached;
forming control regions on the substrate where the first species are not to be attached; and
comparing signals from the sample regions and the control regions to thereby ascertain background radiation not associated with the induced radiation.

55. The method of claim 45, wherein immobilizing a first species comprises:
forming a first plurality of sample regions on the substrate where the first species are to be attached;
forming a second plurality of sample regions on the substrate where a third species are to be attached;
comparing signals from the first and second sample regions.

56. The method of claim 55, wherein comparing comprises:
determining relative concentrations of the first and third biological species.

57. The method of claim 55, wherein comparing comprises:
reducing false positive identification of the biological material by comparing for known attachments of the third biological species to known epitomes of the first biological species.
